(19) United States
(12) Patent Application Publication
(10) Pub. No.: US 2003/0182227 A1
(43) Pub. Date: Sep. 25, 2003

(54) Payment monitoring system

(76) Inventor: Eri Guzman, San Juan, PR (US)

Correspondence Address: Patent Law Offices of Heath W. Hoglund, 256 Eleanor Roosevelt, San Juan, PR, 00918, US

(21) Appl. No.: 10/105,466

(22) Filed: Mar. 25, 2002

(51) Int. Cl. G06F 17/60

(52) U.S. Cl. 705/39

(57) ABSTRACT

A method of monitoring the status of an electronic transaction, (e.g. an ACH transaction) is described. The method presents status information of the electronic transactions to a merchant through a computer interface (e.g. browser). The interface permits the merchant to monitor transactions in an efficient and timely manner.

### FIELD OF THE INVENTION

The invention relates generally to a system for monitoring the status of electronic payment transactions made to a merchant's account in payment for goods or services from a customer, and more particularly to monitoring electronic payment transactions made by a check verification and guarantee service to the merchant's account.

### BACKGROUND OF THE INVENTION

Check verification and guarantee systems are widely used by merchants. When receiving a check from a customer, the merchant accesses by telephone or electronic network, a verification and guarantee service provider. The merchant provides the details of the check, and the service provider determines whether the check is credible and likely to be honored by the issuing bank. The service provider may simply provide an indication as to the credibility of the check or may issue a guarantee for the check. Based upon the feedback from the service provider, the merchant then makes a decision as to whether the check will be accepted. If it is accepted, it is soon deposited and eventually credited to the merchant's account.

As an alternative to depositing a paper check directly, a merchant may instead use electronic check conversion. This process operates by accepting a check at a merchant location. The check is fed through a check reader that scans the MICR line from the check. This provides bank routing and check identification information. The merchant also enters check amount information. The check information is then transmitted to a check verification and guarantee service provider. Again, the provider may simply provide an indication as to the credibility of the check or may issue a guarantee for the check. If the merchant elects to accept the check, the check is physically returned to the customer, and a receipt is presented to the customer authorizing the merchant to submit the check to the issuing bank electronically through an automated clearing house (ACH). When executed, the merchant authorizes the service provider to effect the electronic transfer. The service provider automatically transfers the funds to the merchant's account.

Because many consumers prefer to use paper checks over debit or credit cards, paper checks are widely used by consumers and accepted by merchants. Where a merchant executes a large number of transactions, the burden of monitoring the deposit of paper checks or the electronic transfer of funds through an ACH can become enormously burdensome. Generally, this information is provided by monthly (or more frequent) statements from the merchant's bank as well as the check guarantee service provider. The burden of rectifying these statements and of tracking to ensure that checks are not returned, presents a challenge to many merchants. Accordingly, an improved method of monitoring these transactions is desired.

### SUMMARY OF THE INVENTION

In accordance with preferred embodiments of the invention, a merchant is able to monitor transfers made into a merchant bank account by a check guarantee service. The merchant accesses a central database maintained by the check guarantee service through a browser interface.

According to one preferred embodiment of the invention, a merchant is able to monitor the transfer of funds in conjunction with a sales transaction between a merchant and a purchaser. The transfer of funds is initiated through a point of sale terminal and executed through an electronic funds clearing house. The method is performed through an Internet browser. The merchant provides a unique merchant identifier and password to access records in a central database. The merchant selects batch search criteria, including a start and end date, for application to the central database to identify records that meet the batch search criteria and are associated with the merchant identifier. The merchant views a listing of records that meet the batch search criteria and are associated with the merchant identifier.

According to further aspects of the invention, the merchant views the listing of records as a plurality of individual batch records. Each batch record includes a sum of electronic transactions that executed during an associated batch period.

The merchant views the monitoring options that include a profile option and a transactions options. The profile option displays the merchant information. The transactions option permits the merchant to select the batch search criteria.

The merchant views the date, time and amount of the sales transactions along with the listing of records. The merchant also views the check number, approval number of the sales transactions.

The merchant also selects one of the sales transactions from the listing of records. The merchant then views status information for the sales transaction. The status information indicates whether the transfer of funds has cleared or remains pending. The status information also indicates whether the transfer of funds was guaranteed by a third party.

The data presented to the merchant is accumulated through merchant sales transactions. These are initiated by transmitting a merchant identifier, a purchaser account number and a transaction amount through a point of sale terminal to the central database. The central database then transmits a transaction identifier to the point of sale terminal.

According to another aspect of the invention, a merchant monitors the transfer of funds in conjunction a sales transaction. The transfer of funds is made by a third party to the sales transaction. The merchant transmits a transit number, account number, check number and a purchase amount through a point of sale terminal from a merchant station to a central processing station. This information is determined from a check tendered to the merchant. This is repeated for multiple transactions. The central processing station is operated by the third party to the sales transaction.

The merchant receives an authorization code through the point of sale terminal at the merchant station from the central process station. The authorization code guarantees an electronic transfer of funds into a merchant account in the purchase amount from the third party. This authorization is performed once for each of the multiple transactions.

The merchant subsequently accesses a central database configured to maintain records of purchaser account numbers, transaction numbers, purchase amounts, authorization codes and electronic transfers of funds each associated with a merchant, by transmitting a merchant identifier and a password through a remote computer. The merchant identifier and password permit access only to records in the central database associated with the merchant.

The merchant selects a date range of transactions stored on the central database.

The merchant receives from the central database a listing of transactions that have been executed during the date range, wherein the listing of transactions is presented on the remote computer. Although the central database maintains records for many merchants, only those transactions associated with the particular merchant ID are provided.

The merchant selects one transaction from the listing of transactions.

The merchant receives the transit number, account number, check number, purchase amount, authorization code and status of the electronic transfer of funds associated with the selected transaction. Each are presented on the remote computer screen.

According to another aspect of the invention, a check guarantee system operates a database. The database is established for a plurality of merchant entries. Each merchant entry is associated with a merchant having at least one remote merchant location. The check guarantee system receives a guarantee request from a remote merchant location. The guarantee request includes a merchant identifier, an account number, a check number and an amount. The check guarantee system determines the credibility of the guarantee request based upon the account number. The check guarantee system transmits a guarantee number to the remote merchant location in response to the guarantee request. The guarantee number represents an obligation to transfer funds into an account associated with the remote merchant location. The obligation must be executed within a fixed number of days. The transfer is made by electronic funds transfer. The check guarantee system stores the account number, the check number, the amount, the guarantee number and a date and time associated with the guarantee number in the database as a record associated with the respective merchant entry. The guarantee system receives a request from the respective merchant to determine the status of the obligation to transfer funds. The request includes the merchant identifier and a password. Upon receiving a merchant inquiry, the database is accessed to authenticate the merchant identifier and the password. After authentication, a date range request is also received from the merchant. The check guarantee system accesses the database to select each record associated with the merchant identifier that falls within the date range. These are transmitted for presentation to the respective merchant at a remote user interface.

### BRIEF DESCRIPTION OF THE FIGURES

FIG. 1 is a block diagram of a network configured to issue check payment guarantees to merchants.

FIG. 2 is a flow chart showing one preferred method of issuing a guarantee for an electronic check conversion transaction.

FIG. 3 is a block diagram of a network configured to provide a merchant status information on an electronic transaction.

FIG. 4 is flow chart showing one preferred method of presenting payment and guarantee information to a merchant. The information is presented to the merchant through a computer interface. FIGS. 5-10 illustrate screen diagrams of the computer interface.

FIG. 5 is a screen diagram of a computer interface configured to request merchant ID and password information.

FIG. 6 is a screen diagram of a computer interface configured to present site options to the user.

FIG. 7 is a screen diagram of a computer interface configured to present merchant profile information.

FIG. 8 is a screen diagram of a computer interface configured to present transaction search options as well as transaction data.

FIG. 9 is a screen diagram of a computer interface configured to present details of a single batch of transactions,

FIG. 10 is a screen diagram of a computer interface configured to present details of a single transaction.

### DETAILED DESCRIPTION OF THE INVENTION

To overcome the difficulties associated with monitoring the status of an electronic check conversion made through a guarantee service provider, the database of transaction data is made available to a merchant through a browser interface. This avoids the need for the merchant to obtain a bank statement in order to verify that a particular transaction, or group of transactions, have been credited to its account. It permits convenient access to the transaction data by providing the transaction data through the guarantee service provider. Although this information is not an actual statement from the merchant's bank, it provides a reliable indication of the credits to the merchant's account.

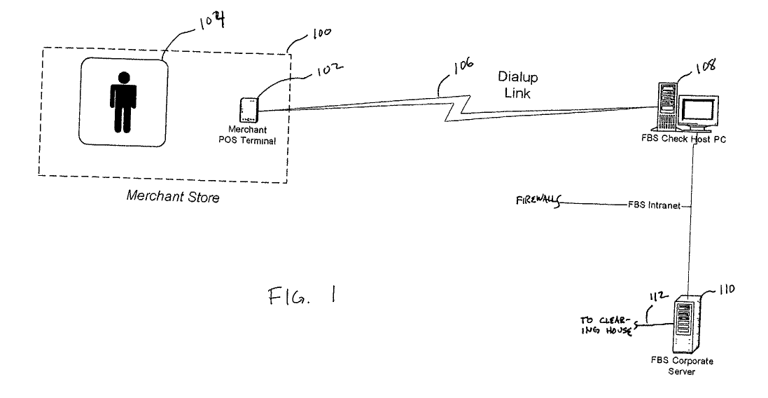

Turning to FIG. 1, an ACH system is described. The ACH system includes a number of merchant stores. One such merchant store 100 is shown. The merchant store operates a point of sale (POS) terminal 102. These POS terminals are widely available and commonly used to execute check, credit, debit and other financial transactions. The POS terminal 102 is configured to communicate transaction data with a remote computer. When a customer presents a bank check 104 as payment, the merchant activates the POS terminal 102. The bank check 104 is scanned through POS terminal 102 and the MICR line is automatically read and converted into an electronic data string that represents the transit number, account number and check number. The merchant also enters a check amount. This data is then transmitted through a dial-up link 106 to a check host server 108. Merchant identification is also transmitted along with the check data.

The check host server 108 receives the check and merchant data. The check data is compared against a database of credit data to determine the authenticity and credibility of the check. Depending upon the service requested by the merchant, the check host may simply return a credibility indicator to the merchant. The credibility indicator is based upon the credit data available at the check host server 108. If the credit data indicates that the check is likely to be honored, a positive indicator is returned; if not, a negative indicator is returned. The merchant may also request a guarantee from the check host server 108. The guarantee is provided for a fee to the merchant and transfers the risk that the issuing bank will not honor the check from the merchant to the operator of the check host server 108. If the check host server 108 issues a guarantee, then it will transfer to the merchant the check amount, less any applicable fees, even if the bank does not honor the check.

Check host server 108 is also connected through a network to a control console 110. The control console 110 stores the database of credit data used by the check host server 108. The control console 110 also provides an external interface for system control. When the check host server 108 has received a request for a guarantee and obtains inconclusive results from the credit database, the check host server 108 may prompt for approval by a credit manager. The credit manager is prompted through control console 110.

Control console 110 also connects with a bank clearing house through a secure connection 112. The connection 112 is used to make electronic transfers. For an ACH transaction, the paper check is returned to the purchaser at the point of sale. The purchaser signs an authorization for the electronic conversion. The control console 110 directs an electronic funds transfer from the issuing bank to the merchant's account. The details of the transaction are saved in a database that the merchant may access to confirm the transfer of the funds. The operation of this interface is further described below. Preferably, these transactions are accumulated for a one-day period. Then, the electronic transactions are processed together in a batch at the end of the day. A unique batch identifier is assigned to the group of electronic transactions and associated with the respective transaction record in the database.

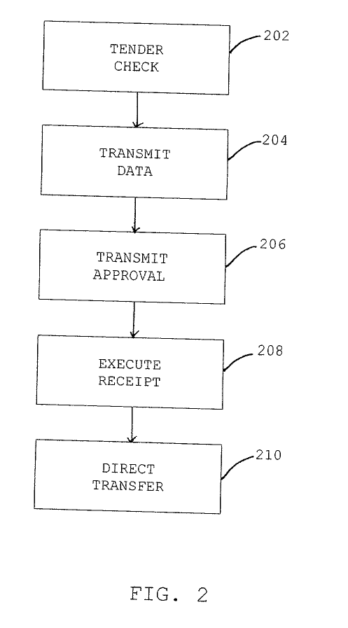

Turning to FIG. 2, one preferred method of operating the ACH system is described. Beginning at step 202, a customer tenders a check at a merchant location. At step 204, the merchant scans the check though a POS terminal, enters the check amount and transfers this data through a dial-up connection to the check host server. A merchant identifier is also transmitted along with the check data.

At step 206, the check host server determines the credibility of the check. If the check is credible, the check host server approves the transaction. It generates both a transaction identifier and a guarantee number that are transmitted back to the merchant POS terminal. In response to this authorization, at step 208, the merchant generates a written authorization form for execution by the purchaser. This form authorizes the merchant to convert the paper check into an electronic transfer. This authorization initiates the electronic transfer of funds, at step 210.

Although ACH systems have are currently available on the market, many merchants prefer to accept other forms of payment because of difficulties associated with monitoring the actual transfer of funds to their account. Providing access to the transaction data directly to the merchant avoids the delay and uncertainty a merchant ordinarily has when accepting check payments.

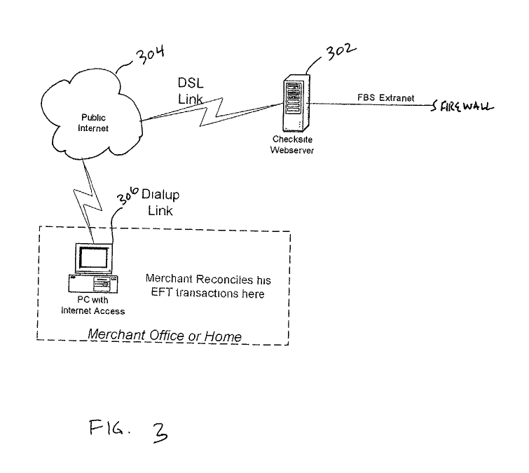

Turning to FIG. 3, one preferred system for providing transaction data to a merchant is described. The system includes a web server 302, on which the transaction data is saved. In operation, transaction data is accumulated on the control console 110. A record of the status of each transaction along with guarantee and identification numbers are also saved. This data is transferred on a periodic basis, preferably at least once per day, from the control console 110 to the web server 302. Since the control console 110 is configured to control electronic transfers, maintaining the security of this computer is essential. To reduce the risk of unauthorized access, the transfer of this data is preferably made through a secure firewall. This firewall prevents an unauthorized user from gaining access to the corporate server through the web server.

Web server 302 connects to the internet 304 and permits merchants to access its data through a web browser. The merchant simply connects to the internet though merchant computer 306. The web server 302 provides transaction data directly to the merchant even before the merchant receives its bank statement or other confirmation from its bank.

As further described below, the web server provides detailed transaction data for ACH transactions. In another preferred embodiment, the control console is further configured to execute credit card, debit card and other electronic transfers received from a merchant through a POS terminal. In this embodiment, the control console provides data to the web server of all electronic transactions. This enables the merchant to track all electronic transactions through a single interface even before receiving a bank statement. It also provides a timely indication, independent of the merchant's bank, of transaction activity.

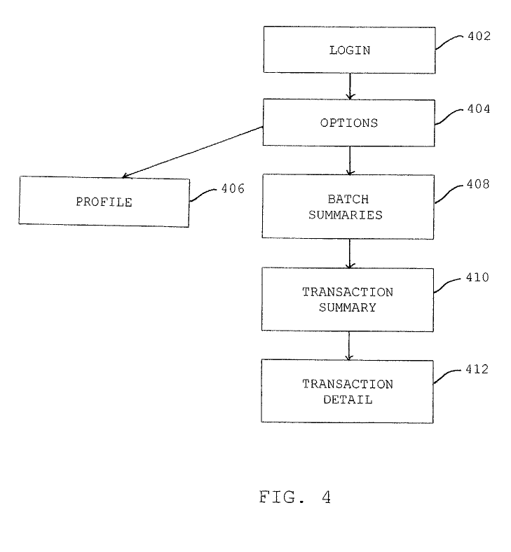

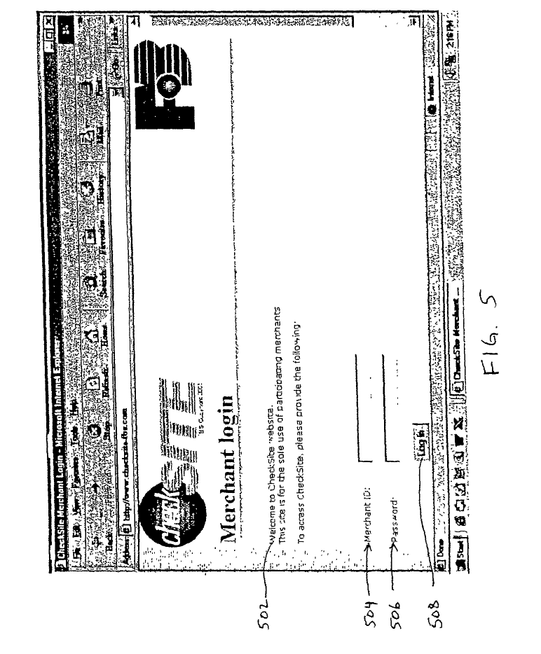

Turning to FIG. 4, one preferred method of presenting payment and guarantee information to a merchant is described. The process uses a computer interface to present information to the merchant and to receive data and commands from the merchant. Preferred and exemplary screen diagrams that are presented to the merchant through a browser interface are shown and described with reference to FIGS. 5 through 10.

Preferably, a database of merchant information is accessed through a computer network such as the Internet. A central database maintains merchant account and transaction data. A merchant accesses this database through a remote computer. Beginning at step 402, the merchant simply enters an internet address through a browser interface to access a login screen. One preferred login screen is shown in FIG. 5. It includes a message area 502. The database administrator can update this message to provide information to the merchants that use the system. At this screen, however, access is not restricted so that any messages should not contain confidential or otherwise sensitive information. Below the message area 502, merchant ID field 504 and password field 506 prompt the merchant to provide these identifiers. The merchant ID and password are used to restrict access to the central database and are used to access relevant information in the central database. After entering the merchant ID and password, the merchant activates login button 508 and the merchant ID and password are transmitted to the central database for verification. Other electronic identification systems may be used in addition to or as an alternative.

If the merchant ID and password match a database entry, then an options screen is presented at step 404, shown in FIG. 4. If the merchant ID and password do not match, then the login screen is presented again with a failure notice. If the merchant has lost the access information, he or she can contact the database administrator to obtain this information.

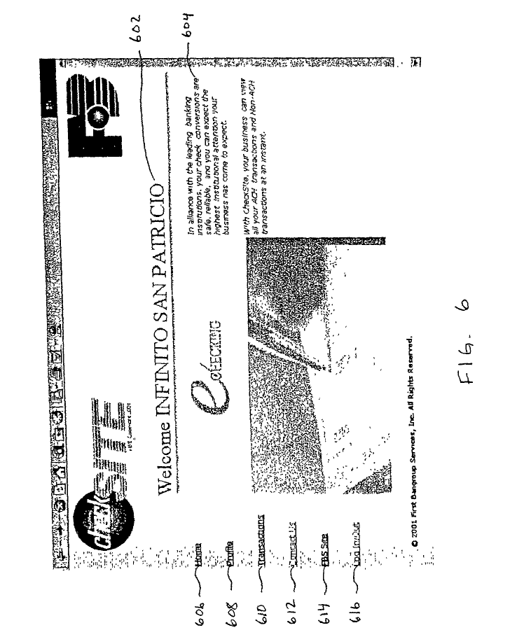

One preferred options screen is shown in FIG. 6. It includes a personalized welcome message 602. Specifically, the welcome message 602 includes the merchant's name. This information is obtained from the database record associated with the merchant ID and password. The options screen also includes a promotional message 604. These can be updated from time to time to present a message to any or all registered merchants. The options screen also includes links 606-616. These are presented on the screens after a merchant logs in so that he or she can easily navigate the system and conveniently jump to any desired feature.

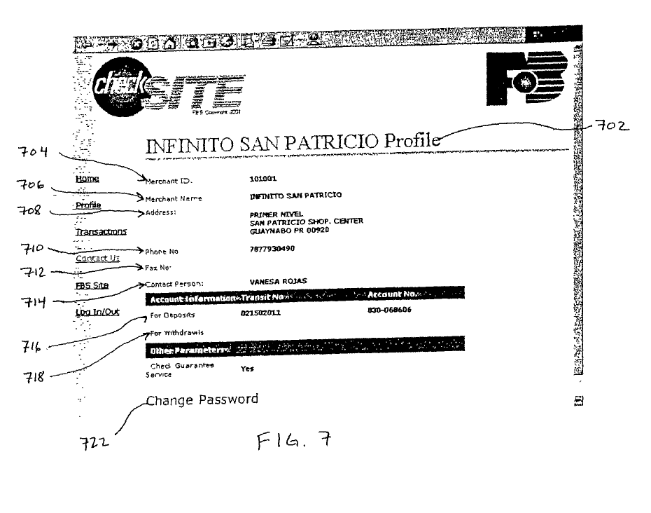

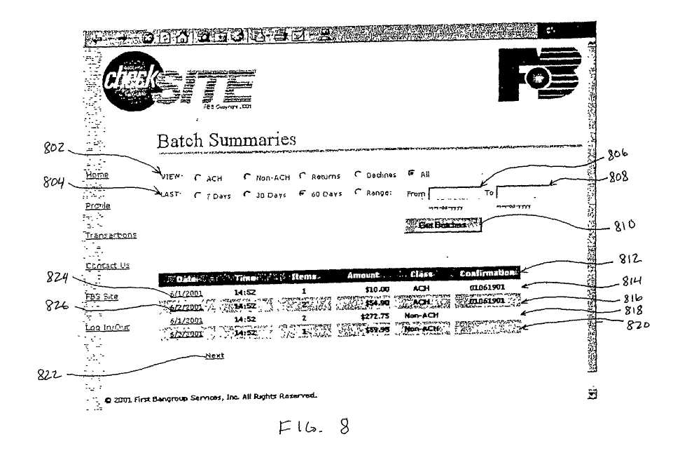

The home link 606, returns the merchant to the options screen, which is shown in FIG. 6. The profile link 608 takes the merchant to a profile screen, which permits the merchant to review and update user information and the password. If the merchant selects the profile link 608, then a profile screen is generated by the central database and transmitted to the merchant's computer at step 406, shown in FIG. 4. After reviewing or changing any merchant information, the merchant can return to the options screen or select any of the other links 612, 614 or 616. The profile screen is further described below with reference to FIG. 7. The transaction link 610 takes the merchant to a transaction screen, which permits the merchant to interrogate the central database for check transactions that the merchant has executed. Each merchant's access is restricted to his or her own records only. The transaction screen is further described below with reference to FIG. 8. The contact link 612 takes the merchant to a contact screen. It provides a link to send an e-mail along with telephone number(s) and related contact information of the service provider. The logout link 616 automatically logs off the merchant from the database access session. The merchant is returned to the initial login screen.

If the merchant selects the profile link, the profile screen is presented at step 406, shown in FIG. 4. One preferred profile screen is shown in FIG. 7. As with the options screen, profile screen includes links along its left border. Its body includes merchant header 702, which includes the merchant's name. Below the merchant header 702, a number of fields list additional merchant information. These fields include a merchant ID field 704, a merchant name field 706, an address field 708, a telephone field 710, a facsimile field 712, and a contact field 714. The merchant ID field lists the merchant ID, which is used to access entries in the central database associated with the respective merchant. The merchant name field 706 lists the merchant's name. The address field 708 lists the merchant's address. The telephone field 710 and facsimile field 712 list the merchant's telephone and facsimile numbers, if any. The contact field 714 lists the name of the person responsible for the merchant's account. The information for these fields is drawn from the central database by accessing the merchant ID.

In addition to fields 704-714, the profile screen also includes merchant account information. Specifically, the profile screen includes a deposit account identifier 716 for making deposits. This identifier is used to direct transfers to the merchant's account. It also includes a withdraw account identifier 718. This identifier is used to direct transfers from the merchant's account. Depending upon the particular merchant, this field may not be used.

Finally, the profile screen includes a change password field 722. By selecting this, a merchant may update his or her password. In order to effect a change in password, the user must enter the current password for the merchant. This avoids unintended or unauthorized changes.

From the profile screen, a user may return to the options screen by selecting the appropriate link, or may jump to another screen. Again, at the options screen, a user may select the transaction link. This brings the user to step 408, shown in FIG. 4, where the transaction screen is presented.

Turning to FIG. 8, one preferred options screen is described. It includes a type selection 802 and a date range selection 804. The type selection 802 permits the user to select between various transaction types that the merchant may have made. These include ACH, non-ACH, returns, declines or an all option. The ACH option displays only transactions that were executed as ACH transactions. Similarly, the non-ACH option displays only transactions that were executed as non-ACH transactions (i.e., a paper check). The returns option displays only transactions that were returned. And the declines option displays only transactions that were declined. The all options selects all types. Generally a merchant may assume that all transactions have cleared. By selecting the returns option, the merchant is able to view only those paper checks that were returned by a bank. Similarly, by selecting the declines button, the merchant may view only those electronic transactions that were declined by the bank. This permits the merchant to more quickly identify failed transactions and to contact the offending purchaser. It also simplifies the process of rectifying the merchant's banks statements.

The date range selection 804 permits the user to select the last seven days, the last thirty days, the last sixty days or a specific range. If a specific range is selected, then the user must also enter a start and end date in from field 806 and to field 808. After making these selections, the user activates the get batches button 810 to perform a search of the central database. The central database queries all records associated with the merchant to determine which records meet the search criteria. The matching records are presented through the options screen.

By default, the all option in the type selection 802 and the last sixty days option in the date range selection 804 are chosen and the associated batches listed at the bottom of the options screen. Specifically, a batch header 812 lists the various fields that are displayed. These include a date, time, items, amount, class and confirmation number fields. Beneath the date and time fields, the appropriate information is listed for each transaction 814-820. Beneath the item field, the number of items associated with the particular batch is identified. Beneath the amount field, the value of the batch is listed. Beneath the class field, the transaction type is shown. These include ACH or non-ACH. Finally, beneath the confirmation field, a confirmation number is listed, if any. The confirmation number is generated when the electronic transfer is made at the end of a day or other batch period. For future reference, the merchant may use this confirmation number to identify a particular batch. This number may serve as proof that a particular batch was executed through the central database.

By listing the ACH and non-ACH transactions in batches, the merchant is able to reconcile its account in a timely and efficient manner. At the end of the day, the merchant simply totals all ACH and non-ACH transactions then compares this total with the batch total listed for the same day. If the two agree, the merchant has a reliable indicator that all transfers have been made. If the two do not agree or if the merchant wants more specific information on a batch, it is obtained through a transaction summary described below.

Where the number of batches exceeds the available screen space, a next link 822 is provided. In many cases, there is not enough screen space to present all records that met the search criteria. Activation of this field causes the option screen to display the next transactions that meet the search criteria.

Each of the transactions 814-820 includes an active area. Specifically, the date field associated with each of the transaction 814-820 is an active area. By selecting this active area, a merchant can display additional information associated with the particular batch. For example, transaction 814 includes active area 824, and transaction 816 includes active area 826. Selection of these active areas prompts the central database to provide further details of the associated batch. With reference to FIG. 4, the batch details are displayed at step 410.

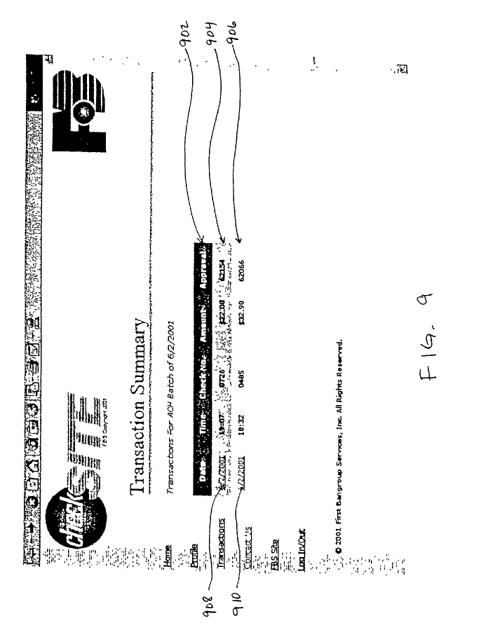

Turning to FIG. 9, one preferred batch screen is described. This particular batch screen shows details of batch 816. The batch screen includes a transaction header 902. This header separates the date, time, check number, amount and approval number for each ACH transaction. These fields are listed below the header 902 for each of the transactions 904 and 906. The batch screen permits a merchant to reconcile his or her account as to which specific ACH transactions have been executed with a batch on any given day. The full list of transactions contained within a specific batch is presented.

Each of the transactions 904 and 906 include an active area associated with the date field. Specifically, transaction 904 includes active area 908 and transaction 906 includes active area 910. By selecting an active area, the user is able to drill-down to obtain more specific information on the associated transaction. With reference to FIG. 4, a transaction detail is displayed at step 412.

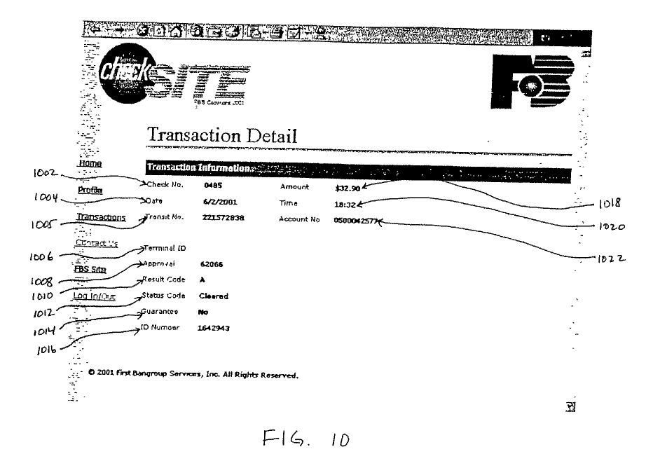

Turning to FIG. 10, one preferred transaction detail screen is described. This particular screen is generated by the merchant selecting active area 910 associated with transaction 906 in FIG. 9. The transaction detail screen includes check number field 1002, date field 1004, transaction number field 1005, terminal ID field 1006, approval field 1008, result code field 1010, status code field 1012, guarantee field 1014, ID number field 1016, amount field 1018, time field 1020 and account number field 1022. These fields present data associated with a specific transaction.

Where a merchant requests a guarantee of a check through the central database, the complete details of that transaction are saved as a record. Where available, the record includes each of the above fields 1002-1022. The data for the check number, amount and account number fields are obtained directly from the subject check. The transit number is the unique character string that identifies the issuing bank. The terminal ID is a unique identifier assigned to each merchant station. When available, it is saved with the other transaction data. The approval number is generated by the central database and provides a guarantee to the merchant for the particular transaction.

The result code indicates the result of the transaction request from the merchant. For example, for a check guarantee request, the request may be approved or rejected by the central database. This result is saved with the associated transaction record

The status code field 1012 indicates the status of the associated money transfer to the merchant account. For an ACH transaction, the transfer may have cleared the issuing bank, may remain pending or may be returned by the issuing bank. This field indicates this status.

The guarantee field 1014 indicates whether the central database issued a guarantee. It is a binary field indicating either yes or no. The check transfers are processed in a batch that is sent on a periodic basis. The batch ID field 1016 indicates a group of checks that were processed together.

By the above-described interface, a merchant may easily monitor the status of their account and determine whether particular transactions have been credited to their account. Although the system has been described with reference to specific preferred embodiments, those skilled in the art will appreciate that many variations and modifications are possible without departing from the scope of the invention. All such variations and modifications are intended to be encompassed within the scope of the following claims.

I claim:

1. A method of monitoring the transfer of funds in conjunction with a sales transaction between a merchant and a purchaser, wherein the transfer of funds is initiated through a point of sale terminal and executed through an electronic funds clearing house, and wherein the method is performed through an Internet browser, comprising the steps of:
providing a unique merchant identifier and password to access records in a central database;
selecting batch search criteria for application to the central database to identify records that meet the batch search criteria and are associated with the merchant identifier; and
viewing a listing of records that meet the batch search criteria and are associated with the merchant identifier.

2. The method of claim 1, wherein the step of viewing the listing of records comprises viewing a plurality of individual batch records, wherein each batch record includes a sum of electronic transactions that executed during an associated batch period.

3. The method of claim 1, wherein the step of selecting the batch criteria comprises selecting a date range including a start date and an end date.

4. The method of claim 1, further comprising the step of viewing a set of monitoring options after the step of providing the unique merchant identifier and password, wherein the monitoring options include:
a profile option that displays the merchant information; and
a transactions option that permits the merchant to select the batch search criteria.

5. The method of claim 4, further comprising the steps of:
selecting the profile option from the set of monitoring options; and
viewing the merchant name and deposit account information.

6. The method of claim 1, wherein the step of viewing the listing of records comprises viewing the date, time and amount of the sales transactions.

7. The method of claim 6, wherein the step of viewing the listing of records further comprises viewing the check number and approval number of the sales transactions.

8. The method of claim 7, further comprising the steps of:
selecting one of the sales transactions from the listing of records; and
viewing status information for the sales transaction, wherein the status information indicates whether the transfer of funds has cleared or remains pending, and further indicates whether the transfer of funds was guaranteed by a third party.

9. The method of claim 1, further comprising the step of transmitting a merchant identifier, a purchaser account number and a transaction amount through the point of sale terminal to the central database.

10. The method of claim 9, further comprising the step of transmitting a transaction identifier from the central database to the point of sale terminal.

11. A method of monitoring the transfer of funds in conjunction a sales transaction between a merchant and a purchaser where the transfer of funds is made by a third party to the sales transaction comprising the steps of:
transmitting a transit number, account number, check number and a purchase amount through a point of sale terminal from a merchant station to a central processing station, wherein the central processing station is operated by the third party to the sales transaction, and wherein the step is repeated for multiple transactions;
receiving an authorization code through the point of sale terminal at the merchant station from the central process station, wherein the authorization code guarantees an electronic transfer of funds into a merchant account in the purchase amount from the third party, wherein the step is executed once for each of the multiple transactions;
accessing a central database configured to maintain records of purchaser account numbers, transaction numbers, purchase amounts, authorization codes and electronic transfers of funds each associated with a merchant, by transmitting a merchant identifier and a password through a remote computer, wherein the merchant identifier and password permit access only to records in the central database associated with the merchant;
selecting a date range of transactions stored on the central database;
receiving from the central database a listing of transactions that have been executed during the date range, wherein the listing of transactions is presented on the remote computer;
selecting one transaction from the listing of transactions; and
receiving the transit number, account number, check number, purchase amount, authorization code and status of the electronic transfer of funds associated with the selected transaction, wherein each are presented on the remote computer screen.

12. The method of claim 11, wherein the step of transmitting transit number, account number, check number and purchase amount comprises determining the transit number, account number, check number and purchase amount from a check tendered by the purchaser at the merchant station.

13. The method of claim 11, wherein the step of receiving the authorization code through the point of sale terminal at the merchant station from the central process station comprises receiving a unique code associated with the transaction, and wherein the unique code is generated at the central processing station only if the central processing station determines that the transit number, account number, check number and purchase amount meet predetermined indicia of credibility.

14. The method of claim 11, wherein the step of accessing the central database comprises entering the merchant identifier and password through an electronic form presented at the remote computer, and wherein the central database associates any transaction data received from the merchant station with the merchant identifier and password.

15. The method of claim 14, wherein a unique merchant identifier and a unique password are assigned to each of a plurality of merchants.

16. The method of claim 15, wherein the step of receiving from the central database the listing of transactions that have been executed, further comprises receiving only the transactions in the central database associated with the merchant identifier, and wherein a transaction identifier associated with each transaction is received from the central database.

17. The method of claim 16, wherein the step of selecting one transaction comprises transmitting one transaction identifier from the remote computer to the central database that identifies the selected transaction.

18. The method of claim 11, wherein the step of selecting the date range comprises selecting a start date and an end date.

19. The method of claim 11, wherein the step of selecting the date range comprises selecting a fixed number of days preceding a current date.

20. The method of claim 11, wherein the step of receiving the transit number, account number, check number, purchase amount, authorization number and status of the electronic transfer of funds associated with the selected transaction comprises receiving an account number and a check number from a printed check.

21. A method of depositing and monitoring account credits received by bank check in conjunction with a sales transaction where the account credits are made by a third party to the sales transaction comprising:
entering a transit number, account number, check number and a check amount associated with a bank check at a merchant location;
transmitting a merchant identifier associated with the merchant location, transit number, account number, check number and the check amount through a first electronic network to a check clearing center;
receiving an authorization code from the check clearing center through the first electronic network after the check clearing center has authorized the credibility of the bank check;
accessing a database maintained by the check clearing center through a second electronic network by providing a merchant identifier and a password, wherein the merchant identifier and password permits access to records in the database associated with the merchant identifier;
selecting a date range having a start and an end date by transmitting a date range identifier through the second electronic network to the check clearing center;
receiving a listing of transactions associated with the merchant identifier through the second electronic network from the check clearing center;
selecting one transaction from the listing of transactions by transmitting a transaction identifier through the second electronic network to the check clearing center; and
receiving the status of the selected transaction through the second electronic network.

22. The method of claim 21, wherein the step of entering the transit number, account number, check number and the check amount comprises optically scanning the bank check to determine the transit number, account number and check number and entering the check amount through a keypad.

23. The method of claim 21, wherein the step of transmitting the merchant identifier associated with the merchant location, the transit number, account number, check number and the check amount comprises establishing a modem connection with the check clearing center.

24. The method of claim 21, wherein the step of receiving the authorization code from the check clearing center comprises receiving a unique character string that is associated in the database with the transit number, account number, check number and the check amount, and wherein the unique character string guarantees an account credit in the check amount by the check clearing center.

25. The method of claim 21, wherein the step of selecting the date range comprises transmitting the date range identifier that selects transactions made during a fixed period of days prior to the current date.

26. The method of claim 21, wherein the step of selecting the date range comprises transmitting the date range identifier that selects transactions made on or after a first date and on or before a second date, wherein the second date is later than the first date, and wherein the first date and the second date are both identified by the date range identifier.

27. The method of claim 21, wherein the step of accessing the database maintained by the check clearing center through the second electronic network comprises transmitting data through an electronic computer network.

28. The method of claim 21, wherein the step of receiving the listing of transactions comprises receiving a listing of dates, amounts and batch identification numbers for batches executed on a periodic basis, wherein each batch includes a plurality of check transactions.

29. The method of claim 21, wherein the step of receiving the listing of transactions comprises receiving for each entry in the listing of transactions data representing the transaction date, time, number of items, amount, class and confirmation number.

30. The method of claim 28, wherein the step of receiving the listing of transactions comprises receiving the listing of transactions sorted by the listing of dates.

31. The method of claim 28, wherein the step of receiving the listing of transactions comprises receiving the listing of transactions sorted by the listing of amounts.

32. The method of claim 29, wherein the step of selecting the one transaction from the listing of transactions comprises selecting an active area associated with the one transaction.

33. The method of claim 32, wherein the step of selecting the one transaction from the listing of transactions by selecting the active area associated with the one transaction further comprises selecting the active area associated with a date displayed with the one transaction.

34. The method of claim 21, wherein the step of receiving the status of the selected transaction through the second electronic network comprises receiving data representing a date, time, check number, amount and approval number.

35. The method of claim 21, wherein the step of accessing the database maintained by the check clearing center comprises transmitting information through the first electronic network, which is the same as the first electronic network.

36. A method of operating a database used in conjunction with guaranteeing the payment of check transactions made at a remote merchant location comprising the steps of:
establishing a database having a plurality of merchant entries, each one associated with a merchant having at least one remote merchant location;
receiving a guarantee request from a remote merchant location, wherein the guarantee request includes a merchant identifier, an account number, a check number and an amount;
determining the credibility of the guarantee request based upon the account number;
transmitting a guarantee number to the remote merchant location in response to the guarantee request, wherein the guarantee number represents an obligation to transfer funds into an account associated with the remote merchant location, wherein the obligation must be executed within a fixed number of days and wherein the transfer is made by electronic funds transfer;
storing the account number, the check number, the amount, the guarantee number and a date and time associated with the guarantee number in the database as a record associated with the respective merchant entry;
receiving a request from the respective merchant to determine the status of the obligation to transfer funds, wherein the request includes the merchant identifier and a password;
accessing the database to authenticate the merchant identifier and the password;
receiving a date range request; and
accessing the database to select each record associated with the merchant identifier that falls within the date range; and
transmitting the selected records for presentation to the respective merchant at a remote user interface.
